(19) United States
(12) Patent Application Publication
(10) Pub. No.: US 2019/0114851 A1
(43) Pub. Date: Apr. 18, 2019

(54) SMART KEY SEARCHING METHOD USING PORTABLE TERMINAL

(71) Applicants: HYUNDAI MOTOR COMPANY, Seoul (KR); KIA MOTORS CORPORATION, Seoul (KR)

(72) Inventor: Hwangjik LEE, Anyang-si (KR)

(73) Assignees: HYUNDAI MOTOR COMPANY, Seoul (KR); KIA MOTORS CORPORATION, Seoul (KR)

(21) Appl. No.: 15/826,194

(22) Filed: Nov. 29, 2017

(30) Foreign Application Priority Data
Oct. 18, 2017 (KR) 10-2017-0135394

(51) Int. Cl. G07C 9/00

(52) U.S. Cl. CPC G07C 9/00007; G07C 9/00309; H04W 12/06; G07C 2009/00412; G07C 2009/00769

(57) ABSTRACT

The present disclosure provides a smart key searching method using a portable terminal. The method may include: connecting the portable terminal with a head unit; receiving wireless communication information and a key identifier (ID) from a smart kit unit, wherein the head unit uses the wireless communication information and the key ID to search for a smart key; transmitting, with the head unit, the wireless communication information and the key ID to the portable terminal; setting and activating, with the portable terminal, a wireless communication channel based on the wireless communication information; receiving, with the portable terminal, a wireless signal of the smart key; and determining, with the portable terminal, whether the smart key matches a vehicle based on a signal transmitted from the smart key.

### CROSS-REFERENCE TO RELATED APPLICATION

The present application claims priority to and the benefit of Korean Patent Application No. 10-2017-0135394, filed on Oct. 18, 2017, which is incorporated herein by reference in its entirety.

### FIELD

The present disclosure relates to a smart key searching method using a portable terminal that enables a user to search for a lost smart key when the smart key is lost.

### BACKGROUND

The statements in this section merely provide background information related to the present disclosure and may not constitute prior art.

A smart key enables a user to control a vehicle through a communication method such as RF communication without directly or physically contacting the vehicle.

However, since the smart key does not directly contact the vehicle and its size is getting smaller, people may misplace the smart key often and it may take a long time to search for the smart key.

Also, various IT technologies are being applied to vehicles.

In particular, a variety of mobile devices that work with a vehicle head unit have been introduced. For example, a mobile device such as a smart phone is connected to the vehicle head unit in a wireless manner such as Bluetooth to provide a hands-free call service.

The above information disclosed in this section is only for enhancement of understanding of the background of the disclosure and therefore it may contain information that does not form the prior art that is already known to a person of ordinary skill in the art.

### SUMMARY

The present disclosure provides a smart key searching method using a portable terminal. In particular, the present disclosure relates to searching for a lost smart key using a wireless communication unit of the portable terminal (or a smart phone) when a driver misplaces the smart key.

One form of the present disclosure provides a smart key searching method using a portable terminal including connecting the portable terminal with a head unit; receiving wireless communication information and a key identifier (ID) from a smart kit unit, wherein the head unit uses the wireless communication information and the key ID to search for a smart key; transmitting, with the head unit, the wireless communication information and the key ID to the portable terminal; setting and activating, with the portable terminal, a wireless communication channel based on the wireless communication information; receiving, with the portable terminal, a wireless signal of the smart key; and determining, with the portable terminal, whether the smart key matches a vehicle based on a signal transmitted from the smart key.

The smart key searching method may further include, requesting, with the portable terminal, the wireless communication information and the key ID from the head unit.

The smart key searching method may further include, authenticating, with the head unit, the portable terminal.

The smart key searching method may further include, requesting, with the head unit, the wireless communication information and the key ID from the smart kit unit.

The smart key searching method may further include, generating, with the smart kit unit, the wireless communication information and the key ID.

Determining whether the smart key matches a vehicle may include determining, with the portable terminal, whether the key ID matches information received from the smart key.

Determining whether the smart key matches a vehicle may include when it is determined that the key ID matches the information received form the smart key, generating, with the portable terminal, a smart key detection signal.

Determining whether the smart key matches a vehicle may include when it is determined that the key ID does not match the information received from the smart key, maintaining a state in which the wireless communication channel is activated.

Connecting the portable terminal with the head unit may include connecting the portable terminal with the head unit in a wireless manner or in a wired manner.

Connecting the portable terminal with the head unit may include connecting the portable terminal with the head unit in a wired manner through a USB terminal.

Connecting the portable terminal with the head unit may include connecting the portable terminal with the head unit in a wireless manner through a server.

Authenticating the portable terminal may be performed when the portable terminal scans a QR code generated by the head unit.

Authenticating the portable terminal may be performed by confirming member information through a server.

The wireless communication information may include a predetermined wireless communication method and a predetermined channel/frequency.

The key ID may be encrypted based on a predetermined method.

In some forms of the present disclosure, a lost smart key may be searched for and found using a portable terminal, thereby reducing the cost of purchasing and re-registering a new smart key.

Also, through a separate authentication process, a portable terminal of a user's name as well as a portable terminal of other user may be authenticated.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic diagram showing a smart key searching system using a portable terminal;

FIG. 2 is a flowchart showing a smart key searching method using a portable terminal;

FIG. 3 is a table summarizing an authentication method in a smart key searching method;

FIG. 4 is a table summarizing a key ID and wireless communication information in a smart key searching method;

FIG. 5 is a table summarizing a wireless communication method in a smart key searching method;

FIG. 6 is a front view of a portable terminal in a smart key searching method; and

FIG. 7 is a flowchart showing a smart key searching.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, exemplary forms of the present disclosure will be described with reference to the accompanying drawings.

However, since a size and a thickness of each configuration shown in the drawings are arbitrarily shown for convenience of explanation, the present disclosure is not necessarily limited to that shown in the drawings, and the thickness is enlarged to clearly represent various parts and regions.

However, in order to clearly describe the forms of the present disclosure, parts that are not related to the description are omitted. Throughout the specification, the same reference numeral is assigned to the same or similar components.

In the description below, names of the components are denoted by first, second, and so on to distinguish them from each other since the names of the components are the same and are not necessarily limited to the order.

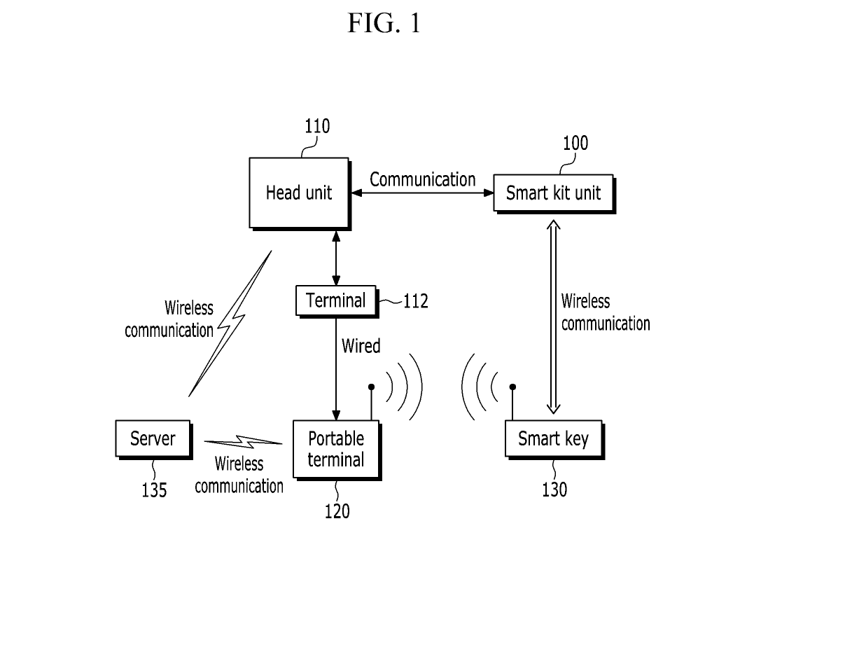

FIG. 1 is a schematic diagram showing a smart key searching system using a portable terminal in some forms of the present disclosure.

Referring to FIG. 1, the smart key searching system includes a head unit 110, a smart kit unit 100, a server 135, a portable terminal 120, a terminal 112 and a smart key 130.

The head unit 110 Head UNIT is referred to as an AVN or an infortainment unit, etc. and controls audio, video, and navigation, and provides travel information necessary for a driver and information such as music, video, etc. The head unit 110 is connected with the smart kit unit 100 through CAN communication.

In some forms of the present disclosure, if the smart key 130 approaches a vehicle, the smart kit unit 100 may sense this and may perform a welcome mode such as turning on a lamp of the vehicle or opening side mirrors.

Here, the smart kit unit 100 and the smart key 130 may transmit and receive signals through a predetermined wireless communication channel and may perform the welcome mode when it is determined that a key ID transmitted from the smart key 130 matches the vehicle.

Also, the smart kit unit 100 may generate the key ID corresponding to the vehicle, determine whether a signal generated by the smart key 130 matches the key ID, communicate with the smart key 130, and perform a series of related control.

The portable terminal 120 is connected with the head unit 110 in a wired manner or a wireless manner. When they are connected to each other in a wired manner, the portable terminal 120 may be connected with the head unit 110 through the USB terminal 112.

Then, the portable terminal 120 may scan a QR code generated on a screen of the head unit 110 and may be authenticated through an operation of verifying this performed by the head unit 110.

When the portable terminal 120 and the head unit 110 are connected to each other in a wireless manner, they may be connected to each other through wireless communication by passing through the telematics server 135 and the portable terminal 120 may be authenticated based on the telematics server 135 or may be authenticated through member information.

When the portable terminal 120 is authenticated, the head unit 110 requests wireless communication information and the key ID from the smart kit unit 100, the smart kit unit 100 transmits the generated wireless communication information and the key ID to the head unit 110, and the head unit 110 transmits this to the portable terminal 120.

When the smart key 130 is lost, a user connects the portable terminal 120 to the head unit 110 in a wired manner or a wireless manner, and the portable terminal 120 is authenticated. Then, the portable terminal 120 receives the wireless communication information and the key ID from the head unit 110.

The portable terminal 120 activates a wireless communication channel and frequency, etc. using the received wireless communication information and wirelessly transmits and receives signals to and from the lost smart key 130.

Then, the portable terminal 120 determines whether the key ID matches the smart key 130 using transmitted and received data and generates a detection signal of the smart key 130 when the key ID matches the smart key 130.

Also, if the key ID does not match or there is no data transmitted/received to/from the smart key 130, the wireless communication channel and frequency are continuously activated to search for the lost smart key 130.

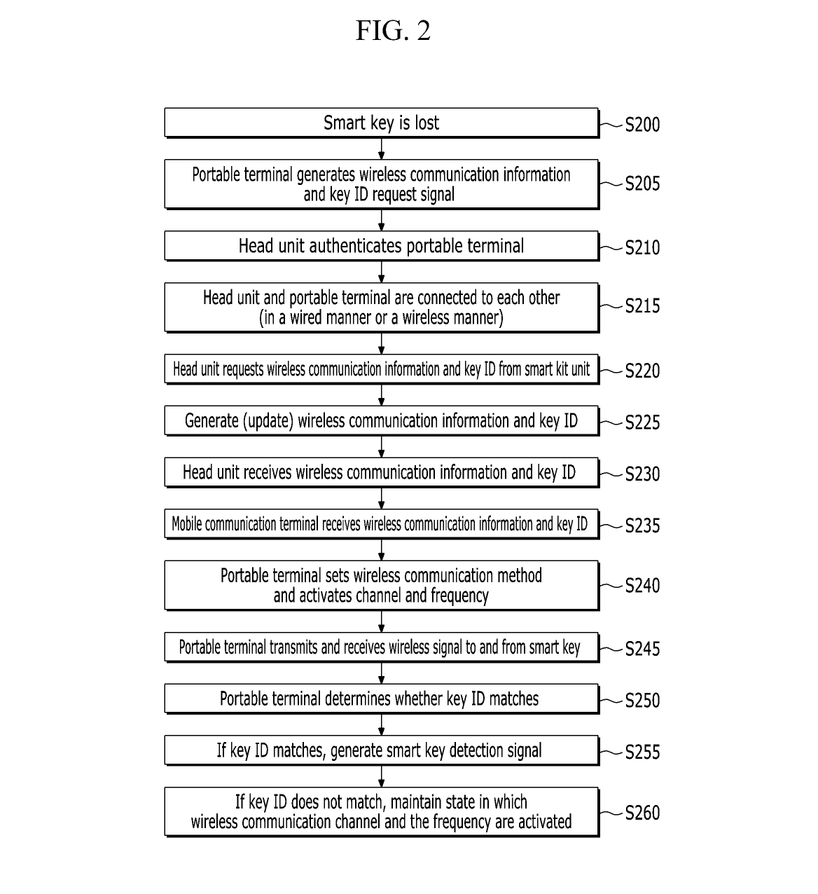

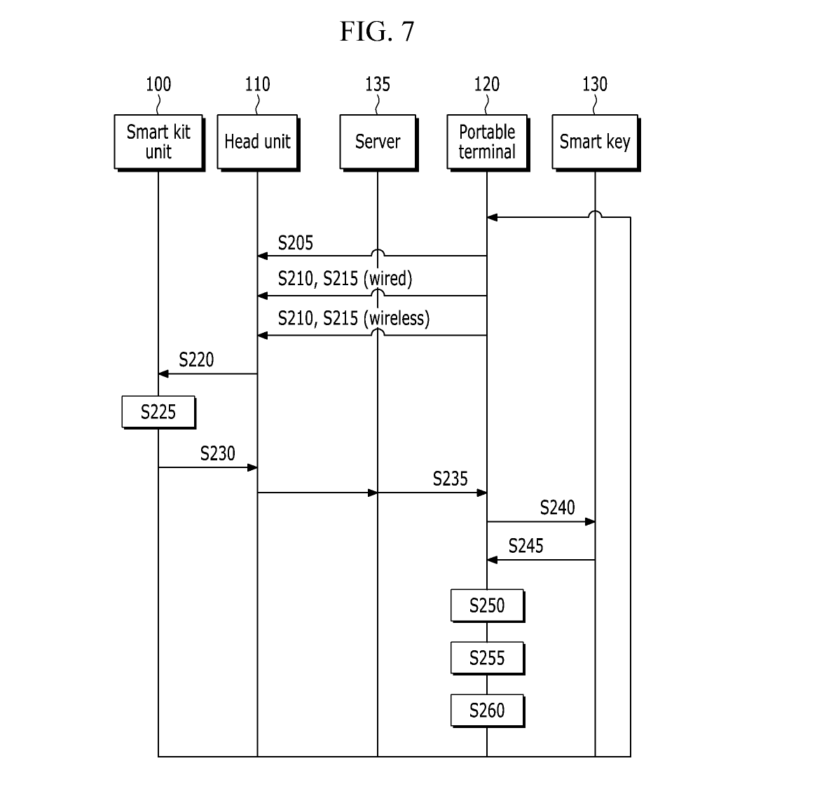

FIG. 2 is a flowchart showing a smart key searching method using a portable terminal in some forms of the present disclosure. FIG. 7 is a flowchart showing a smart key searching method in some forms of the present disclosure.

Referring to FIG. 2 and FIG. 7, in S200, if it is determined that the smart key 130 is lost, in S205, a user allows the portable terminal 120 to generate wireless communication information and a key ID request signal, and the generated signal is received by the head unit 110.

In S210, the head unit 110 authenticates the portable terminal 120. In an authentication method, the portable terminal 120 may scan a QR code generated by the head unit 110 in a wired connection state such that the portable terminal 120 may be authenticated.

Also, in a wireless connection state, the portable terminal 120 may be authenticated based on the telematics server 135, or the portable terminal 120 may be authenticated by member information. Here, a specific process of the authentication method may refer to a well-known technique.

In S215, when the authentication is completed, the head unit 110 and the portable terminal 120 are completely connected to each other in a wired manner or a wireless manner.

In S220, the head unit 110 requests the wireless communication information and the key ID from the smart kit unit 100. Here, the wireless communication information may include a wireless communication method, a channel and a frequency, etc. and the key ID may be a number of the smart key 130 corresponding to a vehicle.

In S225, the smart kit unit 100 generates or updates the wireless communication information and the key ID, and transmits them to the head unit 110. Here, the head unit 110 may transmit and receive data to and from the smart kit unit 100 through CAN communication.

In S230, the head unit 110 receives the wireless communication information and the key ID from the smart kit unit 100, and transmits the wireless communication information and the key ID to the portable terminal 120.

In S235, the portable terminal 120 receives the wireless communication information and the key ID from the head unit 110 in a wired manner or a wireless manner.

In S240, the portable terminal 120 sets a wireless communication method based on the received data, and activates a channel and frequency.

In S245, a condition for transmitting/receiving a wireless signal to/from the smart key 130 is satisfied through the set wireless communication method and the activated channel/frequency. In S250, the portable terminal 120 determines whether the key ID transmitted from the head unit 110 matches a key ID transmitted from the smart key 130.

In S255, if it is determined that the key ID matches, the portable terminal 120 generates a smart key detection signal and notifies a user of the portable terminal 120 (smart phone). The user confirms the notification signal, and searches for the lost smart key 130 nearby.

In S260, if it is determined that the key ID does not match, the portable terminal 120 maintains a state in which the wireless communication channel and the frequency are activated and continuously searches for the lost portable terminal 120.

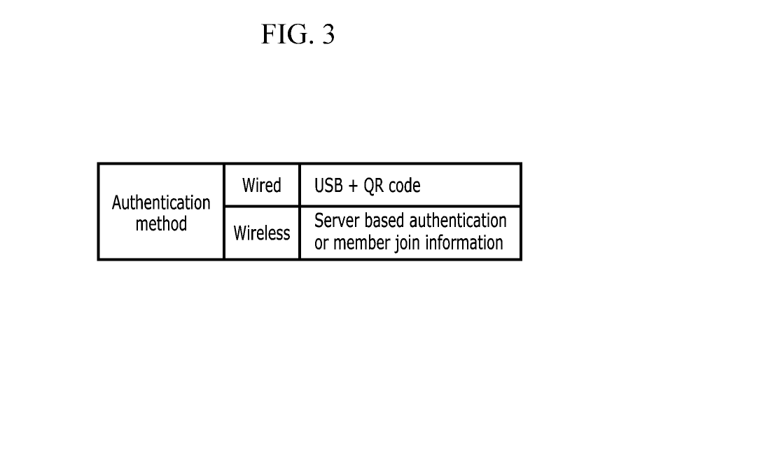

FIG. 3 is a table summarizing an authentication method in a smart key searching method in some forms of the present disclosure.

Referring to FIG. 3, as a method by which the head unit 110 authenticates the portable terminal 120, the USB terminal 112 and a QR code are used in a wired connection state of the head unit 110 and the portable terminal 120.

In a wireless connection state of the head unit 110 and the portable terminal 120, authentication is performed based on the telematics server 135 or authentication is performed using member information.

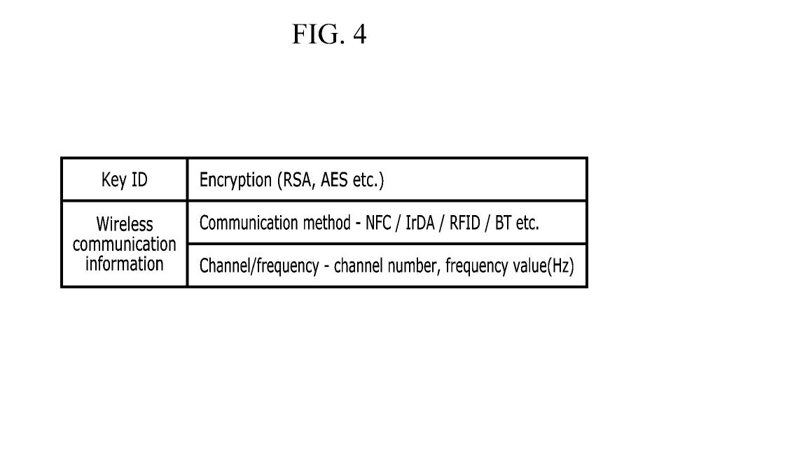

FIG. 4 is a table summarizing a key ID and wireless communication information in a smart key searching method in some forms of the present disclosure.

Referring to FIG. 4, the smart kit unit 100 generates or renews the key ID and the wireless communication information. The key ID is encrypted. An encryption method includes RSA or AES, etc.

Also, the wireless communication includes a communication method and a channel and a frequency. The communication method includes NFC, IrDA, RFID, or BT (Bluetooth), etc. The channel and the frequency include a channel number and a frequency value (Hz).

In some forms of the present disclosure, the smart kit unit 100, the smart key 130, the portable terminal 120, and the smart key 130 may transmit and receive data through a frequency of a predetermined channel using a predetermined communication method.

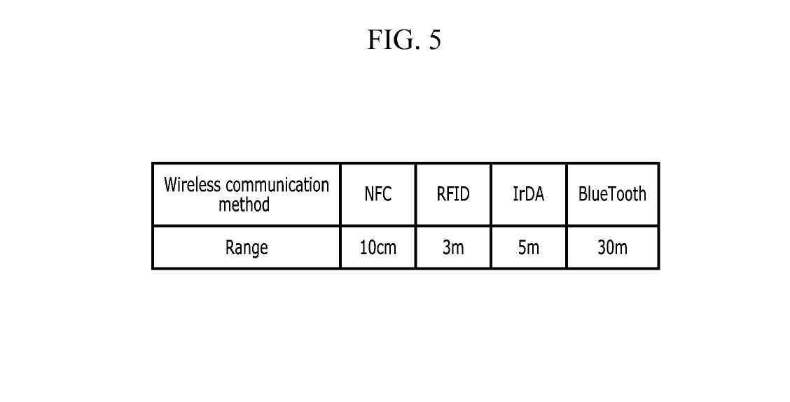

FIG. 5 is a table summarizing a wireless communication method in a smart key searching method in some forms of the present disclosure.

Referring to FIG. 5, as the wireless communication, a communication range of NFC may be within 10 cm, a communication range of RFID may be within 3 m, a communication range of IrDA may be within 5 m, and a communication range of Bluetooth (BT) may be within 30 m.

If it is determined that the portable terminal 120 has detected the smart key 130, when the communication method is Bluetooth, it may be understood that a smart key is present within 30 m.

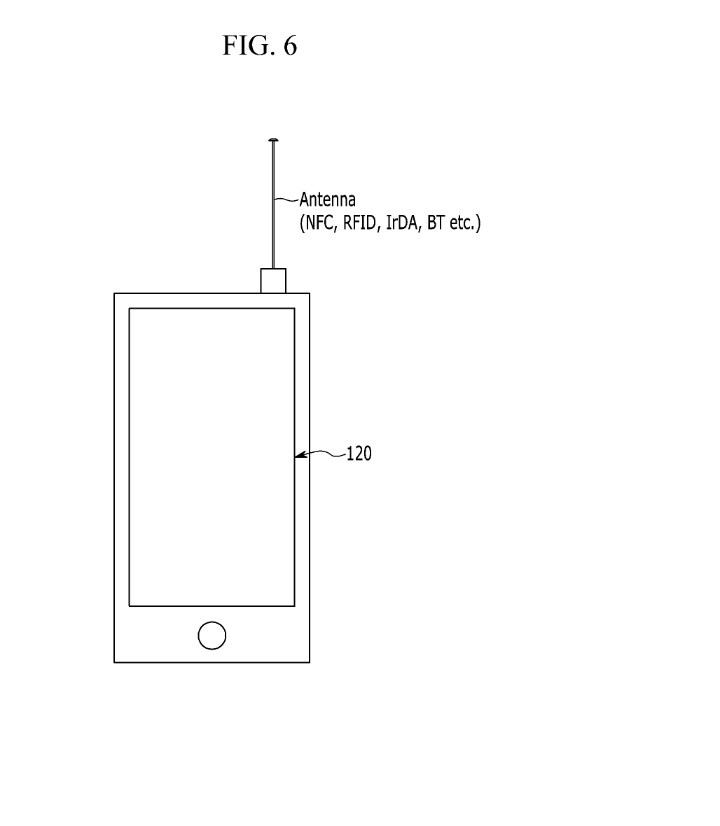

FIG. 6 is a front view of a portable terminal in a smart key searching method in some forms of the present disclosure.

Referring to FIG. 6, in order for the portable terminal 120 to transmit and receive data to and from the portable terminal 120, a separate antenna may be mounted on the portable terminal 120. The antenna may perform NFC, RFID, IrDA, or BT communication.

The description of the disclosure is merely exemplary in nature and, thus, variations that do not depart from the substance of the disclosure are intended to be within the scope of the disclosure. Such variations are not to be regarded as a departure from the spirit and scope of the disclosure.

### DESCRIPTION OF SYMBOLS

100: smart kit unit 110: head unit
112: terminal 130: smart key
120: portable terminal 135: server

1. A smart key searching method using a portable device, the method comprising:
detecting, with an Audio, Video, Navigation (“AVN”) system, that the portable device is connected to the AVN system;
receiving wireless communication information and a key identifier (ID) from a smart kit, wherein the AVN system uses the wireless communication information and the key ID to search for a smart key;
transmitting, with the AVN system, the wireless communication information and the key ID to the portable device;
setting and activating, with the portable device, a wireless communication channel based on the wireless communication information;
receiving, with the portable device, a wireless signal of the smart key; and
determining, with the portable device, whether the smart key matches a vehicle based on a signal transmitted from the smart key.

2. The smart key searching method of claim 1, wherein the method further comprises:
requesting, with the portable device, the wireless communication information and the key ID from the AVN system.

3. The smart key searching method of claim 2, wherein the method further comprises:
authenticating, with the AVN system, the portable device.

4. The smart key searching method of claim 1, wherein the method further comprises:
requesting, with the AVN system, the wireless communication information and the key ID from the smart kit.

5. The smart key searching method of claim 4, wherein the method further comprises:
generating, with the smart kit unit, the wireless communication information and the key ID.

6. The smart key searching method of claim 1, wherein determining whether the smart key matches the vehicle comprises:
determining, with the portable device, whether the key ID matches information received from the smart key.

7. The smart key searching method of claim 6, wherein determining whether the smart key matches the vehicle comprises:
when it is determined that the key ID matches the information received from the smart key, generating, with the portable device, a smart key detection signal.

8. The smart key searching method of claim 6, wherein determining whether the smart key matches the vehicle comprises:
when it is determined that the key ID does not match the information received from the smart key, maintaining a state in which the wireless communication channel is activated.

9. The smart key searching method of claim 1, wherein detecting that the portable device is connected to the AVN system comprises:
detecting, with the AVN system, that the portable device is connected to the AVN system in a wireless manner or in a wired manner.

10. The smart key searching method of claim 9, wherein detecting that the portable device is connected to the AVN system comprises:
detecting, with the AVN system, that the portable device is connected to the AVN system in the wired manner through a USB terminal.

11. The smart key searching method of claim 9, wherein detecting whether the portable device is connected to the AVN system comprises:
detecting, with the AVN system, the portable device when the portable device is connected to the AVN system in the wireless manner through a server.

12. The smart key searching method of claim 3, wherein:
authenticating the portable device is performed when the portable device is configured to scan a QR code generated by the AVN system.

13. The smart key searching method of claim 3, wherein:
authenticating the portable device is performed by confirming member information through the server.

14. The smart key searching method of claim 1, wherein the wireless communication information comprises:
a predetermined wireless communication method; and
a predetermined channel/frequency.

15. The smart key searching method of claim 1, wherein:
the key ID is encrypted based on a predetermined method.
